(19) United States
(12) Patent Application Publication
(10) Pub. No.: US 2015/0116743 A1
(43) Pub. Date: Apr. 30, 2015

(54) IMAGE FORMING APPARATUS, SHEET TYPE DETECTING METHOD AND STORAGE MEDIUM STORING PROGRAM OF SHEET TYPE DETECTING METHOD

(71) Applicant: KYOCERA Document Solutions Inc., Osaka (JP)

(72) Inventor: Hiroshi YAMASHITA, Osaka (JP)

(73) Assignee: KYOCERA DOCUMENT SOLUTIONS INC., Osaka (JP)

(21) Appl. No.: 14/525,407

(22) Filed: Oct. 28, 2014

(30) Foreign Application Priority Data
Oct. 31, 2013 (JP) 2013-226654

(51) Int. Cl. H04N 1/00; G06K 15/00; G06K 15/10; G06K 15/16; G06K 15/02; G06K 15/14

(52) U.S. Cl. CPC H04N 1/00092; G06K 15/021; G06K 15/14; G06K 15/102; G06K 15/16; G06K 15/408; G06K 15/4065; G06K 15/005; H04N 1/00384; H04N 1/00411; H04N 1/00477; H04N 1/00726; H04N 1/0071; H04N 1/00734; H04N 1/00771; H04N 2201/0091; H04N 2201/0094
USPC 358/1.12

(57) ABSTRACT

An image forming apparatus includes a stopping part, a mode deciding part, a changing part and a type distinguishing part. The stopping part temporarily stops print execution if a type value indicating a type of a sheet conveyed according to the print execution is not included within a given range. The mode deciding part decides whether or not a mode set in the print execution is a specific mode using a different sheet from a sheet used in normal print condition. The changing part changes, if the mode set in the print execution is the specific mode, a width value used for distinguishing the sheet type to a first width value smaller than a normal width value. The type distinguishing part measures the type value and decides whether or not the type value is included within a threshold range defined by the changed width value.

### INCORPORATION BY REFERENCE

This application is based on and claims the benefit of priority from Japanese Patent application No. 2013-226654 filed on Oct. 31, 2013, the entire contents of which are incorporated herein by reference.

### BACKGROUND

The present disclosure relates to an image forming apparatus, a sheet type detecting method and a storage medium storing program of the sheet type detecting method. In detail, the present disclosure relates to the image forming apparatus, sheet type detecting method and storage medium storing program of the sheet type detecting method, which are able to suitably detect a type of a sheet and to avoid occurrence of an error.

A type of a recording paper used in an image forming apparatus, such as a copying machine, a laser printer or an inkjet printer is varied in thickness, grammage, surface nature, material quality and others. In a case where image forming with the same process condition is performed to such various types of the recording papers, there is a problem that an excellent image is outputted to one type of the recording paper, but the excellent image cannot be obtained in another type of the recording paper.

Particularly, with regard to the surface nature of the recording paper, because process condition (e.g. fixing temperature and others of an electrographic device using a heat fixing manner) for obtaining most excellent output image is different between a recording paper with a smooth surface and another recording paper with great irregularities (a rough paper), great difference of image quality is caused between the different papers in a case of outputting in the same process condition.

Therefore, for example, there is a controlling method of an image forming apparatus including a conveying means conveying a recording paper to an image forming part via a predetermined conveying path and a reading means reading surface nature of the recording paper on the conveying path. This controlling method controls the conveying means and reading means so that, in a situation where a first recording paper firstly conveying on the conveying path in continuous printing is temporarily stopped, the surface nature of the recording paper is read by the reading means. The controlling method has a paper type distinguishing step distinguishing a paper type of the recording paper in accordance with the surface nature and a setting step setting image forming condition of the image forming part in accordance with a distinguished result. Moreover, the controlling method controls the conveying means and reading means so that, in a situation conveying a following recording paper conveyed on the conveying path after the recording paper, the surface nature of the following recording paper is read by the reading means. The controlling method also has a deciding step deciding in accordance with the surface nature whether or not the paper type of the following recording paper agrees with the paper type of the first recording paper and an operating step applying the image forming condition set in the setting step to the first recording paper and following recording paper to carry out the image forming operation in a case deciding that both paper types agree with each other and applying the image forming condition to the first recording paper and not applying the image forming condition to the following recording paper to carry out the image forming operation in a case deciding that both paper types do not agree with each other. In the paper type distinguishing step, a media sensor capable of reading the surface nature of a sheet is utilized.

However, in the controlling method of the image forming apparatus as mentioned above, there is a possibility that the media sensor distinguishing the paper type mistakes detection due to a read angle of the sheet and other influence, and, when such a misdetection occurs, the image forming operation (printing) is stopped wastefully. Then, it is deemed that there is a problem that a stop time (a down time) of the entire image forming apparatus is increased. When desired by a user, there is a case where, if the paper type is different from the image forming condition, the image is satisfied by being outputted as a printed matter (an outputted matter). In such a case, if the paper type is different, there is a circumstance that it is unnecessary to stop the image forming operation when the paper type is similar.

### SUMMARY

In accordance with one aspect of the present disclosure, an image forming apparatus includes a stopping part, a mode deciding part, a changing part and a type distinguishing part. The stopping part temporarily stops print execution, in a case where a type value indicating a type of a sheet conveyed according to the print execution is not included within a given range. The mode deciding part decides whether or not a mode set in the print execution is a specific mode using a different sheet from a sheet used in normal print condition. The changing part changes, as a result of decision of the mode deciding part, in a case where the mode set in the print execution is the specific mode, a width value used for distinguishing the sheet type to a first width value smaller than a normal width value. The type distinguishing part measures the type value and decides whether or not the type value is included within a threshold range defined by the changed width value.

In accordance with another aspect of the present disclosure, a sheet type detecting method of the image forming apparatus includes a stopping step, a mode deciding step, a changing step and a type distinguishing step. The stopping step temporarily stops print execution, in a case where a type value indicating a type of a sheet conveyed according to the print execution is not included within a given range. The mode deciding step decides whether or not a mode set in the print execution is a specific mode using a different sheet from a sheet used in normal print condition. The changing step changes, as a result of decision of the mode deciding step, in a case where the mode set in the print execution is the specific mode, a width value used for distinguishing the sheet type to a first width value smaller than a normal width value. The type distinguishing step measures the type value and decides whether or not the type value is included within a threshold range defined by the changed width value.

In accordance with another aspect of the present disclosure, a computer readable storage medium stores program for making the computer execute a sheet type detecting method of an image forming apparatus. The sheet type detecting method of the image forming apparatus includes a stopping step, a mode deciding step, a changing step and a type distinguishing step. The stopping step temporarily stops print execution, in a case where a type value indicating a type of a sheet conveyed according to the print execution is not included within a given range. The mode deciding step decides whether or not a mode set in the print execution is a specific mode using a different sheet from a sheet used in normal print condition. The changing step changes, as a result of decision of the mode deciding step, in a case where the mode set in the print execution is the specific mode, a width value used for distinguishing the sheet type to a first width value smaller than a normal width value. The type distinguishing step measures the type value and decides whether or not the type value is included within a threshold range defined by the changed width value.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic diagram showing an entire structure of the inside of a multifunction peripheral according to the present disclosure.

FIG. 2 is a schematic diagram showing an entire structure of an operation part of the multifunction peripheral according to the present disclosure.

FIG. 3 is a block diagram showing a structure of control hardware of the multifunction peripheral according to the present disclosure.

FIG. 4 is a functional block diagram showing the multifunction peripheral according to an embodiment of the present disclosure.

FIG. 5 is a flowchart useful for understanding an execution procedure of the multifunction peripheral according to the embodiment of the present disclosure.

FIG. 6A is a front view schematically showing an operation screen as an example displayed on a touch panel of the multifunction peripheral according to the embodiment of the present disclosure and FIG. 6B is a front view schematically showing a poster print setting screen as an example displayed on the touch panel of the multifunction peripheral according to the embodiment of the present disclosure.

FIG. 7A is a schematic diagram showing a structure of a media sensor in the multifunction peripheral according to the embodiment of the present disclosure and FIG. 7B is a front view schematically showing an error screen as an example displayed on the touch panel of the multifunction peripheral according to the embodiment of the present disclosure.

### DETAILED DESCRIPTION

In the following, with reference to the drawings, an image forming apparatus of an embodiment of the present disclosure will be described in order to understand the present disclosure. The following embodiment is an example concreated the present disclosure, but does not limit the technical range of the present disclosure. Alphabet S affixed before reference numeral in a flowchart means a step.

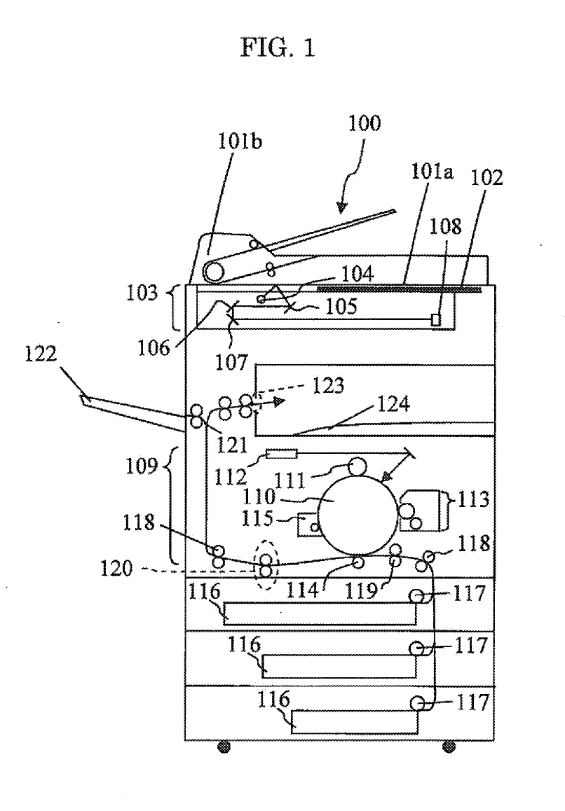

FIG. 1 is a schematic diagram showing an entire structure of the image forming apparatus according to the embodiment of the present disclosure. A detail of each component not relating to directly the present disclosure is omitted.

As the image forming apparatus of the present disclosure, for example, a printer, an independent scanner or a multifunction peripheral composed of a printer, a copier, a scanner, a facsimile and others is corresponded. The multifunction peripheral may works as the image forming apparatus having a copier function, a scanner function, a facsimile function, a printer function and others.

In the following, an operation of the multifunction peripheral 100 (MFP) in a case of utilizing the copier function will be simply described.

First, in a case where a user utilizes the multifunction peripheral 100, a document is placed on a document platen 101a provided in an upper part of a housing part or a placing stage 101b of an automatic document feeding part. The user uses an operation part 102 (an operation panel) arranged near the document platen 101a to enter input of setting condition relating to image forming from an operation screen of the operation part 102. When the user depresses a start key arranged in the operation part 102, the multifunction peripheral 100 starts the image forming (a printing process).

Subsequently, in an image reading part 103, a light emitted from a light source 104 is reflected by the document placed on the document platen 101a. The reflected light is guided to an image sensor 108 by mirrors 105, 106 and 107. The guided light is photoelectrically converted by the image sensor 108 to generate image data corresponding to the document.

Incidentally, a part forming a toner image on the basis of the image data is an image forming part 109. In the image forming part 109, a photosensitive drum 110 is provided. The photosensitive drum 110 is rotated at a constant rate in a predetermined direction and, around it, a charger 111, an exposure unit 112, a developing device 113, a transferring device 114, a cleaning unit 115 and others are located in order from an upstream side of the rotating direction.

The charger 111 electrically charges the surface of the photosensitive drum 110 evenly. The exposure unit 112 emits a laser based on the image data to the surface of the charged photosensitive drum 110 to form an electrostatic latent image. The developing device 113 applies a toner onto the formed electrostatic latent image to form a toner image. The formed toner image is transferred onto a recording medium (e.g. a paper or a sheet) by the transferring device 114. The cleaning unit 115 removes a redundant toner remained on the surface of the photosensitive drum 110. A series of these processes are carried out by rotating the photosensitive drum 110.

The sheet is conveyed from a plurality of sheet feeding cartridges 116 provided in the multifunction peripheral 100. When the sheet is conveyed, the sheet is withdrawn from any one of the sheet feeding cartridges 116 to a conveying path by a pickup roller 117. In the sheet feeding cartridges 116, different paper types of the sheets are respectively stored and the sheet is fed on the basis of the setting condition relating to the image forming.

The sheet withdrawn to the conveying path is sent between the photosensitive drum 110 and transferring device 114 by conveying rollers 118 and registration rollers 119. Onto the sent sheet, the toner image is transferred by the transferring device 114, and then, the sheet is conveyed to a fixing device 120.

When the sheet with the transferred toner image is passed through between a heating roller and a pressuring roller provided in the fixing device 120, heat and pressure are applied onto the toner image, and then, a visible image is fixed onto the sheet. Heat quantity of the heating roller is suitably set in accordance with the paper type, and then, fixing is suitably carried out. When the visible image is fixed onto the sheet, the image forming is completed and the sheet is guided to a path switching part 121 by conveying rollers 118.

The path switching part 121, according to switching direction of the multifunction peripheral 100, guides the sheet to a sheet ejection tray 122 provided at a lateral face of the housing part or guides the sheet to an in-body tray 124 provided inside the housing part via a sheet ejection port 123. The sheet is piled and stored on the sheet ejection tray 122 or the in-body tray 124. By the above-mentioned procedure, the housing part of the multifunction peripheral 100 provides the copier function to the user.

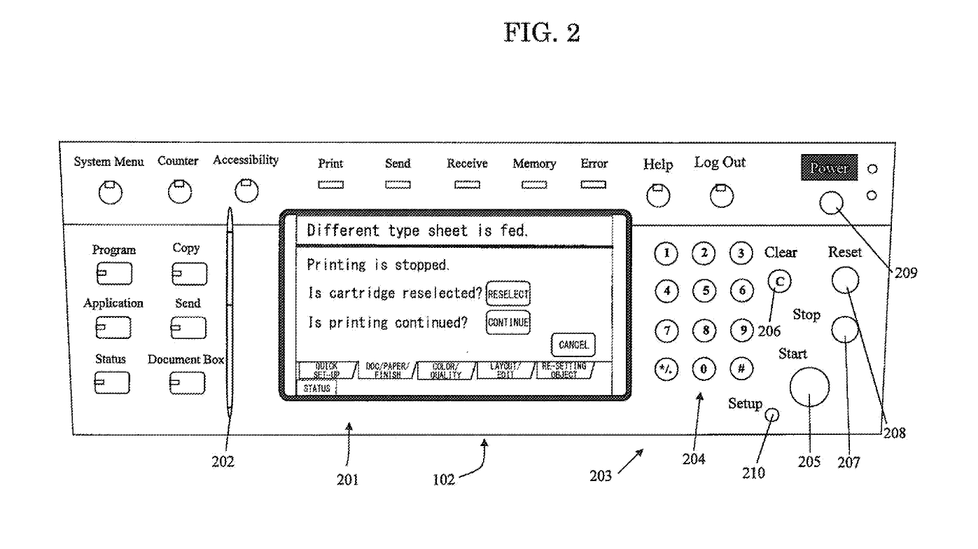

Next, FIG. 2 is a schematic diagram showing an entire structure of the operation part of the multifunction peripheral according to the embodiment of the present disclosure. The user uses the operation part 102 to enter the setting condition about the image forming as mentioned above or to confirm the entered setting condition. In order to enter the setting condition, a touch panel 201 (an operation panel), a touch pen 202 and operation keys 203 arranged in the operation part 102 are used.

The touch panel 201 has a function entering the setting condition and a function displaying the setting condition. That is, by depressing keys in a screen displayed on the touch panel 201, the setting condition corresponding to the depressed key is entered.

In a back face of the touch panel 201, a displaying part (not shown), such as an LCD (Liquid Crystal Display), is arranged and the displaying part displays, for example, an operation screen, such as an initial screen. Near the touch panel 201, the touch pen 202 is provided and, when the user makes a proximal end of the touch pen 202 contact with the touch panel 201, a sensor arranged under the touch panel 201 detects a contact point.

Further, near the touch panel 201, a predetermined number of operation keys 203 are arranged, for example, numerical keys 204, a start key 205, a clear key 206, a stop key 207, a reset key 208 and a power key 209 are provided.

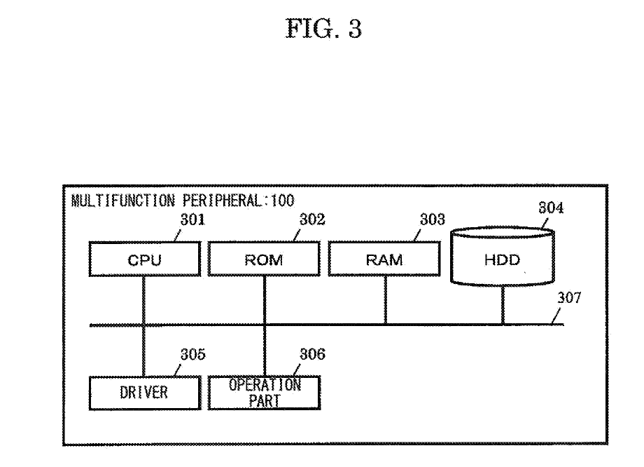

Next, with reference to FIG. 3, a structure of control hardware of the multifunction peripheral 100 will be described. FIG. 3 is a block diagram showing the structure of the control hardware of the multifunction peripheral 100. A detail of each component not relating to directly the present disclosure is omitted.

A control circuit of the multifunction peripheral 100 connects a CPU (Central Processing Unit) 301, a ROM (Read Only Memory) 302, a RAM (Random Access Memory) 303, an HDD (Hard Disk Drive) 304, a driver 305 corresponding to each drive part and the operation part 306 (102) by an internal bus 307.

The CPU 301 uses the RAM 303 as a working area, executes program stored in the ROM 302, HDD 304 and others, transmits and receives with the driver 306 data or direction from the operation part 306 or signal or command corresponding to the key, and then, controls an operation of each drive part shown in FIG. 1.

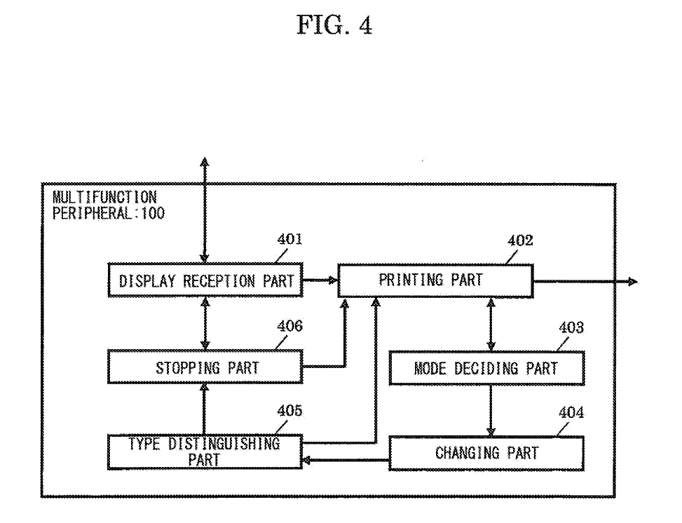

With regard to each component (shown in FIG. 4) mentioned later except for the drive part, the component is actualized by executing the program by the CPU 301. In the ROM 302, HDD 304 and others, the program and data actualizing each component described later are stored.

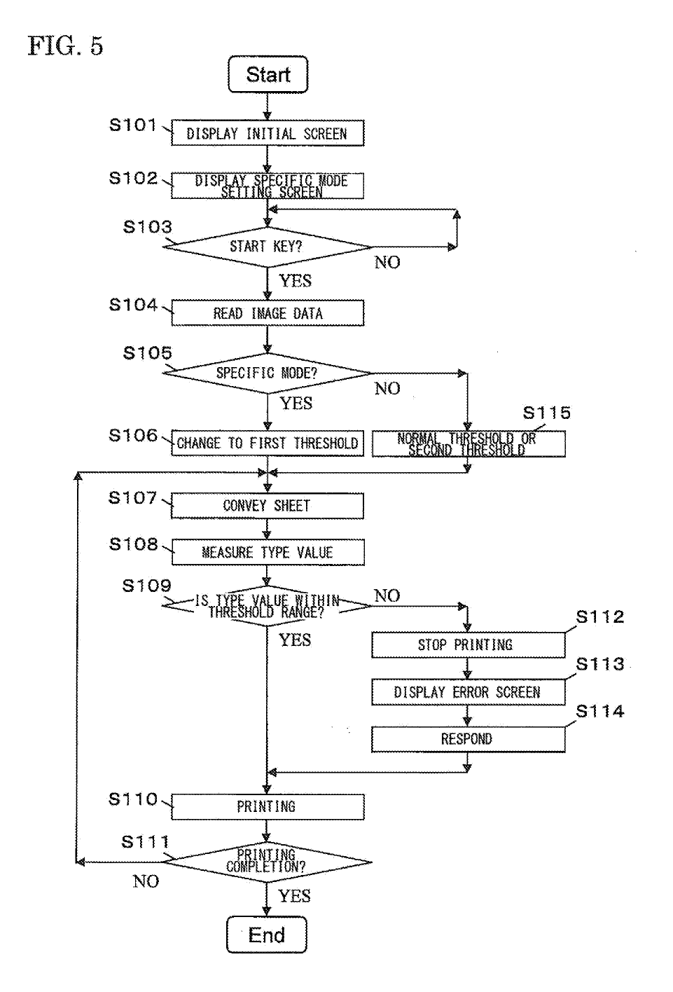

Next, with reference to FIGS. 4 and 5, the structure and execution procedure according to the embodiment of the present disclosure will be described. FIG. 4 is a functional block diagram showing the multifunction peripheral of the present disclosure. FIG. 5 is a flowchart illustrating the execution procedure of the multifunction peripheral of the present disclosure.

First, when the power is supplied to the multifunction peripheral 100 by the user, the multifunction peripheral 100 is started up and a display reception part 401 displays the initial screen (the operation screen) on the touch panel 201 (S101 in FIG. 5).

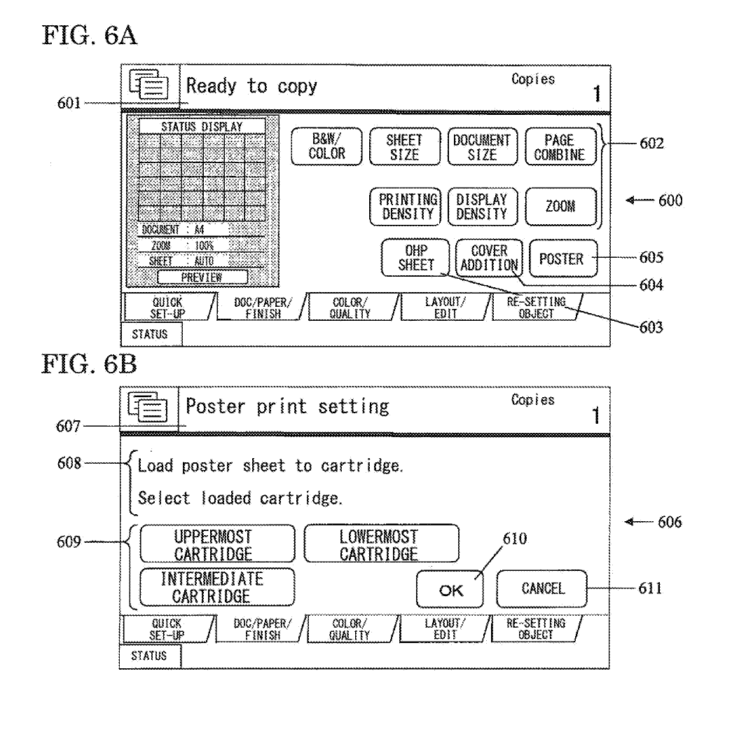

On the initial screen 600, as shown in FIG. 6A, a predetermined message 601 of “Ready to copy” is displayed and functional item keys 602 used for entering the setting condition, such as the copier function, an OHP (Overhead Projector) backing sheet mode key 603 used for setting a print of an OHP backing sheet (an OHP sheet), a cover addition mode key 604 used for setting a print adding a cover and a poster (print) key 605 used for setting a poster print are displayed in a depressible state.

The OHP backing sheet mode key 603, cover addition mode key 604 and poster key 605 are keys for specific modes using different sheets from the sheet used in a normal print condition, and also, keys of modes in which the user desires to avoid mixture of print sheet types in print setting.

For example, when the user intends to perform the poster print and depresses the poster key 605, the display reception part 401 receives the depression of the poster key 605, and then, switches and displays from the initial screen to a specific mode setting screen (here, a poster print setting screen) on the touch panel 201.

On the poster print setting screen 606, as shown in FIG. 6B, a predetermined message 607 of “Poster print setting” and instruction 608 of “Load poster sheet to cartridge. Select loaded cartridge.” are displayed and a plurality of sheet feeding cartridge keys 609 used for selecting each sheet feeding cartridge 116 of the multifunction peripheral 100, an OK key 610 and a cancel key 611 are displayed in a depressible state.

The user looking at the poster print setting screen 606 stores the poster sheet (e.g. a glossy paper or a woodfree paper) to the intermediate stage sheet feeding cartridge 116 among the sheet feeding cartridges 116, and then, depresses the sheet feeding cartridge key 609 corresponding to the intermediate stage sheet feeding cartridge 116 among the sheet feeding cartridge keys 609 on the poster print setting screen 606 and depresses the OK key 610. Accordingly, the display reception part 401 receives poster print setting and selection of the sheet feeding cartridge 116 (the intermediate stage sheet feeding cartridge) stored the poster print sheet. Thereby, the multifunction peripheral 100 is shifted to a state where the poster print setting mode as the specific mode is received.

The user locates the document of the poster on the document platen, and then, enters desired print condition (e.g. 50 sheets as the number of print sheets and others) and depresses the start key 205 (S103: YES in FIG. 5). Accordingly, the display reception part 401 receives the poster print setting mode, print condition and the command from the start key 205 and notifies a printing part 402 to the effect of the reception. The printing part 402 receiving the notification reads the image data of the document of the poster (S104 in FIG. 5).

The printing part 402 notifies, when executing the print under the print condition, a mode deciding part 403 to the effect of the execution. The mode deciding part 403 receiving the notification decides whether or not the mode set in the print execution is the specific mode using the different sheet from the sheet used in the normal print condition (S105 in FIG. 5).

A way in the mode deciding part 403 of deciding whether or not the mode set in the print execution is the specific mode is not restricted and, for example, proposed as follows.

That is, the mode deciding part 403 refers the mode set in the print execution by the printing part 402 and decides to which of the OHP backing sheet mode, cover addition mode and poster print setting mode, referred mode is corresponded.

As a result of the above-mentioned decision, in a case where the mode set in the print execution is the specific mode, for example, in a case where the poster print setting mode is set (S105: YES in FIG. 5), the mode deciding part 403 decides that printing is executed by using the different sheet from the sheet used in the normal print condition and notifies a changing part 404 to the effect of the decision. The changing part 404 receiving the notification changes a width value (a threshold) used for distinguishing the sheet type to a first width value (a first threshold) smaller than the normal width value (S106 in FIG. 5). For example, in a case where the normal width value is 50(−), the changing part 404 changes the width value to the first width value of 10(−). Thereby, it is possible to distinguish the sheet type as mentioned later with high accuracy.

When the changing part 404 completes the change of the first threshold, the changing part 404 notifies the printing part 402 to the effect of the completion. The printing part 402 receiving the notification conveys a predetermined sheet on the basis of the print condition (S107 in FIG. 5). When the printing part 402 conveys the sheet, the printing part 402 notifies a type distinguishing part 405 to the effect of the conveyance. The type distinguishing part 405 receiving the notification measures a type value indicating the type of the sheet conveyed according to the print execution (S108 in FIG. 5) and decides whether or not the type value is included within a threshold range defined by the changed width value (S109 in FIG. 5).

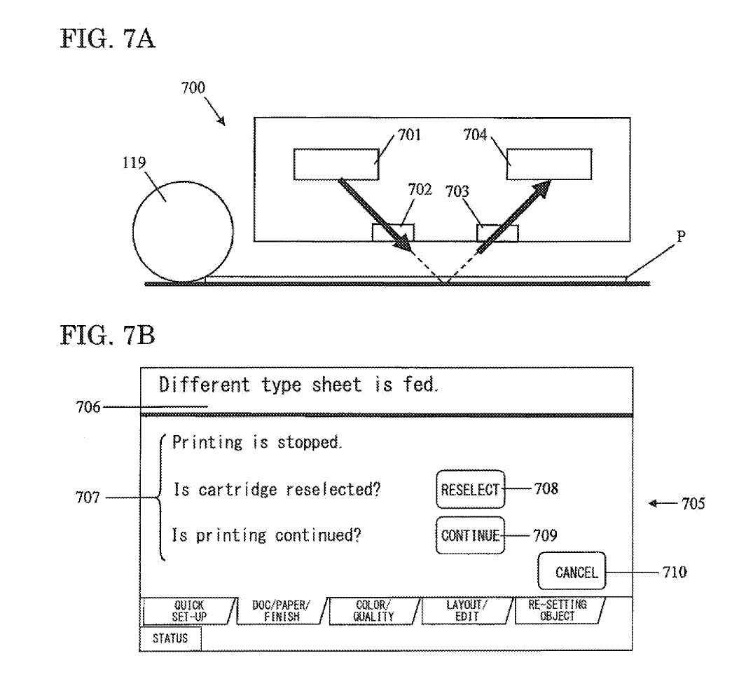

A way in the type distinguishing part 405 of deciding whether or not the type value is included within the threshold range is not restricted and, for example, proposed as follows. That is, first, the type distinguishing part 405 measures, as shown in FIG. 7A, the type value of the sheet by using a media sensor 700 arranged beforehand near the registration rollers 119 correcting inclination and others of the sheet.

The media sensor 700 is configured, for example, so as to emit a light onto a surface of the sheet P temporarily stopped by the registration rollers 119, to condense the light reflected by the sheet P to image the reflected light, and to detect an image of a specific area of the surface of the sheet P.

The media sensor 700 includes a light source LED (Light Emitting Diode) 701 emitting a light, a first imaging lens 702 imaging the light from the light source LED 701, a second imaging lens 703 imaging, when the light imaged by the first imaging lens 702 is reflected by the surface of the sheet P, the reflected light and a CMOS (Complementary Metal Oxide Semiconductor) sensor 704 photographing the imaged reflected light. The light from the light source LED 701 is emitted onto the surface of the sheet P via the first imaging lens 702. The light is reflected by the surface of the sheet P and the reflected light from the sheet P is condensed by the second imaging lens 703 and imaged by the CMOS sensor 704. Thereby, a surface image of the sheet P is photographed, and then, digitalized to a numerical value so that the numerical value is measured as the type value. In place of the CMOS sensor 704, a light quantity sensing element or the like, such as a CCD (Charge Coupled Device) may be applied. As the type value, for example, a characteristic value, such as reflectance or wavelength of the sheet, capable of specifying the sheet type is applied.

When the sheet P conveyed by the printing part 402 is stopped by the registration rollers 119, the type distinguishing part 405 measures the type value of the sheet P by using the media sensor 700 (S108 in FIG. 5). Subsequently, the type distinguishing part 405 decides whether or not the measured type value is included within the threshold range defined by the changed first width value (S109 in FIG. 5).

For example, in a case where the first width value is 10(−), if the type value of the normal sheet set beforehand is 10(−), an upper limit value of the threshold range is determined as 10+10=20(−) by adding the first width value to the type value of the normal sheet and a lower limit value of the threshold range is determined as 10−10=0(−) by subtracting the first width value from the type value of the normal sheet. The type distinguishing part 405 decides whether or not the measured type value is included between the lower limit value and upper limit value.

As a result the decision, in a case where the type value is included within the threshold range (S109: YES in FIG. 5), the type distinguishing part 405 decides that the type of the sheet P is not varied and notifies the printing part 402 to the effect of the decision. The printing part 402 receiving the notification executes printing to the sheet P (S110 in FIG. 5). Concretely, the printing part 402 drives the registration rollers 119 to continue the conveyance of the sheet P, transfers the toner image corresponding to the image data of the document of the poster onto the sheet P, and fixes the toner image onto the sheet P and ejects the sheet P. Thereby, the poster print is executed.

When the printing to the sheet P is completed, the printing part 402 decides on the basis of the print condition whether or not the print execution is completed (S111 in FIG. 5). Concretely, when the printing part 402 completes the printing of one sheet P, a predetermined counter counts the number of the print executed sheets. The printing part 402 decides whether or not the counted number of the print executed sheets agrees with the number of copies (e.g. 50 sheets) of the print condition.

As a result of the decision, in a case where the print execution is not completed (S111: NO in FIG. 5), the execution procedure is returned to step S107, and then, the printing part 402 executes the conveyance of the predetermined sheet (S107 in FIG. 5) and the type distinguishing part 405 measures the type value of the sheet (S108 in FIG. 5) and decides whether or not the type value is included within the threshold range (S109 in FIG. 5).

Incidentally, in a case where the various types of the sheets P is stored in a certain sheet feeding cartridge 116, for example, when the printing part 402 carries out sheet feeding from the certain sheet feeding cartridge 116 and the sheet feeding cartridge 116 is emptied, if the user loads different type sheets and the printing is restarted, the following situation occurs.

That is, in step S109, for example, in a case where, because the sheet P is recycled paper (a thin paper) or the like and the type value is 30(−), as a result of the decision, the type value is not included within the threshold range (S109: NO in FIG. 5), the type distinguishing part 405 decides that the type of the sheet P is varied and notifies a stopping part 406 to the effect the decision. The stopping part 406 receiving the notification temporarily stops the print execution of the printing part 402 (S112 in FIG. 5) and displays an error screen on the touch panel 201 (S113 in FIG. 5).

On the error screen 705, as shown in FIG. 7B, a predetermined message 706 of “Different type sheet is fed.”, instruction 707 of “Printing is stopped. Is cartridge reselected? or Is printing continued?”, a reselection key 708 used for resecting the sheet feeding cartridge 116, a continuance key 709 used for continuing the temporarily stopped printing and a cancel key 710 used for canceling the printing are displayed. Thereby, the user can understand that the different types of the sheets P are mixed by mistaken in the poster print.

The user looking at the error screen 705 determines, for example, not to care about the sheet type and responds to the instruction by depressing the continuance key 709 (S114 in FIG. 5). The stopping part 406 receives the depression of the continuance key 709 and notifies the printing part 402 to the effect of the reception. The printing part 402 continues the temporarily stopped print execution (S110 in FIG. 5). Thereby, the user can perform desired process. As other responses of the user, for example, a response to load again the suitable sheet for the specific mode in the certain sheet feeding cartridge 116 by the user, a response to depress the reselection key 708 and to reselect other sheet feeding cartridge 116 for sheet feeding by the user, a response to depress the cancel key 710 and to cancel the printing by the user or another response may be cited.

After the printing is repeated, in step S111, the number of the print executed sheets agrees with the number of copies of the print condition, as a result of the decision, in a case where the print execution is completed (S111: YES in FIG. 5), the printing part 402 completes all processes. Thereby, the print execution entered by the user is completed entirely.

Incidentally, in step S105, in a case where the user does not set the specific mode, that is, in a case where, as a result of the decision, the mode set in the print execution is not the specific mode (S105: NO in FIG. 5), the mode deciding part 403 decides that the printing is executed without using the different sheet from the sheet used in the normal print condition and notifies the changing part 404 to the effect the decision. The changing part 404 receiving the notification changes the width value distinguishing the sheet type to the normal width value or a second width value larger than the normal width value (a second threshold) (S115 in FIG. 5). For example, in a case where the normal width value is 50(−), the changing part 404 changes the width value to the normal width value 50(−) or the second width value 100(−). Thereby, when the sheet type is distinguished, even if the sheet type is different, the print execution is not temporarily stopped wastefully and it is possible to reduce a down time of the multifunction peripheral 100.

That is, in step S109, when the type distinguishing part 405 decides whether or not the type value is included in the threshold range defined by the width value (S109 in FIG. 5), even if the sheet P is the recycled paper or the like and its type value is 30(−), the upper limit value of the threshold range defined by the normal width value is determined as 10+50=60(−) by adding the normal width value to the type value of the normal sheet and a lower limit value of the threshold range is determined as 10−50=−40(−) by subtracting the normal width value from the type value of the normal sheet. Moreover, the upper limit value of the threshold range defined by the second width value is determined as 10+100=110(−) by adding the second width value to the type value of the normal sheet and a lower limit value of the threshold range is determined as 10−100=−90(−) by subtracting the second width value from the type value of the normal sheet. Thereby, even if the type value is 30(−), because the type value is included within the threshold range, the type distinguishing part 405 decides that the type value is included within the threshold range (S109: YES in FIG. 5) and the printing part 402 executes the printing regardless of the different type sheet (S110 in FIG. 5). Thereby, it is possible to reduce a wasteful down time of the multifunction peripheral 100.

Thus, in the present disclosure, it is configured so as to include the mode deciding part 403, changing part 404 and type distinguishing part 405. The mode deciding part 403 decides whether or not the mode set in the print execution is the specific mode using the different sheet from the sheet used in the normal print condition. The changing part 404 changes, as a result of the decision, in a case where the mode set in the print execution is the specific mode, the width value used for distinguishing the sheet type to the first width value smaller than the normal width value. The type distinguishing part 405 measures the type value indicating the type of the sheet conveyed according to the print execution and decides whether or not the type value is included within the threshold range defined by the changed width value.

Thereby, it is possible to suitably detect the sheet type and to avoid error occurrence. Moreover, by changing accuracy of sheet type decision in according to image forming condition, it is possible to restrain occurrence of stop time.

Although, in the embodiment, the present disclosure is applied to the sheet type detection in printing according to the user's operation in the multifunction peripheral 100, the present disclosure is not restricted by this. The present disclosure may be applied to another image forming apparatus, such as a printer, printing on the basis of image data information transmitted in accordance with image forming instruction from an external terminal.

Although, in the embodiment, the multifunction peripheral 100 is configured so as to include each component, the present disclosure may be configured so that program achieving each component is stored in a storage medium and the storage medium is provided. In such a configuration, the program is read by the multifunction peripheral 100 and the multifunction peripheral 100 achieves each component. In that case, the program read from the storage medium has workings and effects of the present disclosure. The steps executed by each component may be stored in a hard disk drive and executed from the hard disk drive.

The present disclosure may be provided as program to be individually communicated via a telecommunications line or the like and to be executed by a computer. In such a case, a central processing unit (CPU) cooperates with other circuits except for the CPU in accordance with the program of the present disclosure to achieve control operations. Each component achieved by using the program and CPU may be configured by using dedicated hardware. The program may be circulated in a state recorded in a computer readable recording medium, such as a CD-ROM.

As described above, the image forming apparatus and sheet type detecting method according to the present disclosure are useful for not only the multifunction peripheral, but also a scanner, a copying machine, a printer and others, and are effective as an image forming apparatus and a sheet type detecting method which are able to suitably detect a type of a sheet and to avoid occurrence of an error.

What is claimed is:

1. An image forming apparatus comprising:
a stopping part temporarily stopping print execution, in a case where a type value indicating a type of a sheet conveyed according to the print execution is not included within a given range;
a mode deciding part deciding whether or not a mode set in the print execution is a specific mode using a different sheet from a sheet used in normal print condition;
a changing part changing, as a result of decision of the mode deciding part, in a case where the mode set in the print execution is the specific mode, a width value used for distinguishing the sheet type to a first width value smaller than a normal width value; and
a type distinguishing part measuring the type value and deciding whether or not the type value is included within a threshold range defined by the changed width value.

2. The image forming apparatus according to claim 1, wherein
the changing part changes, as a result of the decision of the mode deciding part, in a case where the mode set in the print execution is the specific mode, the width value to the normal width value or a second width value larger than the normal width value.

3. The image forming apparatus according to claim 1, wherein
the stopping part, in a case where the type value is not included within the threshold range, temporarily stops the print execution and displays an error screen.

4. The image forming apparatus according to claim 3, wherein
the error screen displays a reselection key used for resecting a sheet feeding cartridge, a continuance key used for continuing the temporarily stopped printing and a cancel key used for canceling the printing.

5. The image forming apparatus according to claim 1, wherein
the specific mode is any one of an OHP backing sheet mode, a cover addition mode and a poster print setting mode.

6. The image forming apparatus according to claim 1, wherein
the type distinguishing part uses a media sensor in order to measure the type value,
the media sensor is arranged near a registration roller correcting inclination of the sheet so as to emit a light onto a surface of the sheet temporarily stopped by the registration roller, to condense the light reflected by the surface to form an image of the reflected light, and to detect an image of a specific area of the surface of the sheet.

7. The image forming apparatus according to claim 1, wherein
the type value is a characteristic value, such as reflectance or wavelength of the sheet, capable of specifying the sheet type.

8. A sheet type detecting method of an image forming apparatus comprising:
a stopping step temporarily stopping print execution, in a case where a type value indicating a type of a sheet conveyed according to the print execution is not included within a given range;
a mode deciding step deciding whether or not a mode set in the print execution is a specific mode using a different sheet from a sheet used in normal print condition;
a changing step changing, as a result of decision of the mode deciding step, in a case where the mode set in the print execution is the specific mode, a width value used for distinguishing the sheet type to a first width value smaller than a normal width value; and
a type distinguishing step measuring the type value and deciding whether or not the type value is included within a threshold range defined by the changed width value.

9. The sheet type detecting method according to claim 8, wherein
the changing step changes, as a result of the decision of the mode deciding step, in a case where the mode set in the print execution is the specific mode, the width value to the normal width value or a second width value larger than the normal width value.

10. The sheet type detecting method according to claim 8, wherein
the stopping step, in a case where the type value is not included within the threshold range, temporarily stops the print execution and displays an error screen.

11. The sheet type detecting method according to claim 10, wherein
the error screen displays a reselection key used for resecting a sheet feeding cartridge, a continuance key used for continuing the temporarily stopped printing and a cancel key used for canceling the printing.

12. The sheet type detecting method according to claim 8, wherein
the specific mode is any one of an OHP backing sheet mode, a cover addition mode and a poster print setting mode.

13. The sheet type detecting method according to claim 8, wherein
the type distinguishing step uses a media sensor in order to measure the type value,
the media sensor is arranged near a registration roller correcting inclination of the sheet so as to emit a light onto a surface of the sheet temporarily stopped by the registration roller, to condense the light reflected by the surface to form an image of the reflected light, and to detect an image of a specific area of the surface of the sheet.

14. The sheet type detecting method according to claim 8, wherein
the type value is a characteristic value, such as reflectance or wavelength of the sheet, capable of specifying the sheet type.

15. A computer readable storage medium storing program for making the computer execute a sheet type detecting method of an image forming apparatus,
wherein the sheet type detecting method includes:
a stopping step temporarily stopping print execution, in a case where a type value indicating a type of a sheet conveyed according to the print execution is not included within a given range;
a mode deciding step deciding whether or not a mode set in the print execution is a specific mode using a different sheet from a sheet used in normal print condition;
a changing step changing, as a result of decision of the mode deciding step, in a case where the mode set in the print execution is the specific mode, a width value used for distinguishing the sheet type to a first width value smaller than a normal width value; and
a type distinguishing step measuring the type value and deciding whether or not the type value is included within a threshold range defined by the changed width value.

16. The storage medium according to claim 15, wherein
the changing step changes, as a result of the decision of the mode deciding step, in a case where the mode set in the print execution is the specific mode, the width value to the normal width value or a second width value larger than the normal width value.

17. The storage medium according to claim 15, wherein
the stopping step, in a case where the type value is not included within the threshold range, temporarily stops the print execution and displays an error screen.

18. The storage medium according to claim 17, wherein
the error screen displays a reselection key used for resecting a sheet feeding cartridge, a continuance key used for continuing the temporarily stopped printing and a cancel key used for canceling the printing.

19. The storage medium according to claim 15, wherein
the specific mode is any one of an OHP backing sheet mode, a cover addition mode and a poster print setting mode.

20. The storage medium according to claim 15, wherein
the type distinguishing step uses a media sensor in order to measure the type value,
the media sensor is arranged near a registration roller correcting inclination of the sheet so as to emit a light onto a surface of the sheet temporarily stopped by the registration roller, to condense the light reflected by the surface to form an image of the reflected light, and to detect an image of a specific area of the surface of the sheet.
